(19) United States
(12) Patent Application Publication
(10) Pub. No.: US 2019/0353369 A1
(43) Pub. Date: Nov. 21, 2019

(54) ENVIRONMENTAL CONTROL SYSTEM AND METHOD FOR AUTOMATICALLY ADJUSTING OPERATING PARAMETERS

(71) Applicant: Green Air LLC, Fishers, IN (US)

(72) Inventors: Josmon C. George, Fishers, IN (US); Chakola Dhanashree, Fishers, IN (US)

(21) Appl. No.: 16/477,054

(22) PCT Filed: Jan. 11, 2018
(86) PCT No.: PCT/US2018/013406

§ 371 Date: Jul. 10, 2019

Related U.S. Application Data
(60) Provisional application No. 62/444,952, filed on Jan. 11, 2017.

(51) Int. Cl. F24F 11/30; F24F 11/00; F24F 11/52; F24F 11/56; F24F 11/64; F24F 11/65; G05B 19/042

(52) U.S. Cl. CPC F24F 11/30; F24F 11/0008; F24F 11/52; F24F 2110/10; F24F 11/64; F24F 11/65; G05B 19/042; F24F 11/56

(57) ABSTRACT

An environmental control system (10) is provided, and includes an interface module (42) that provides an interface associated with the environmental control system (10) for controlling operation of a network (22) connected to the environmental control system (10) and receiving operating data from at least one sensor associated with a target space. A monitoring module (28) receives the operating data via the interface module (42) and provides environmental condition information about the target space. A detection module (30) examines the operating data for controlling at least one environmental unit, recognizes an environmental condition change, identifies a triggering event defined by a difference between at least two operating parameters of the environmental control system (10), and determines a desired environmental operation based on the difference. An adjustment module (32) adjusts at least one operating parameter of the environmental unit associated with the target space in response to the triggering event.

### CROSS-REFERENCE

This application claims the benefit of U.S. Provisional Patent Application 62/444,952, entitled ENVIRONMENTAL CONTROL SYSTEM AND METHOD FOR AUTOMATICALLY ADJUSTING OPERATING PARAMETERS, and filed Jan. 11, 2017, the disclosure of which is hereby incorporated by reference in its entirety.

### FIELD OF THE DISCLOSURE

The present disclosure generally relates to environmental control systems and methods. More particularly, the present disclosure relates to systems and methods for controlling the heating, cooling and/or humidity levels of the interior of one or more building structures.

### BACKGROUND OF THE DISCLOSURE

Environmental control of confined spaces is generally accomplished through the use of heating, ventilating, air conditioning, and humidity control systems or through the opening of windows and doors. A thermostat is typically used to control environmental systems, whereas a person is required for manually opening and closing doors and windows.

Conventional environmental systems include a thermostat and temperature sensors for determining the temperature within the confined space. Users input desired temperature settings into the thermostat and when the temperature within the confined space is determined to be different from the desired temperature setting, the thermostat acts as an on switch for the environmental system to bring the temperature within the confined space to the desired temperature setting. Likewise, when the temperature within the confined space is determined to be equal to the desired temperature setting, the thermostat acts as an off switch for the environmental system.

Since the mid-1950s energy demand for heating and cooling buildings has risen. For example, approximately twenty percent of the electricity generated in the United States is used only for cooling buildings. As the demand for energy to cool and heat buildings has increased, costs to energy consumers have also risen. Additionally, pollution caused by the production of energy for heating and cooling buildings has also increased.

As a result of the increased energy consumption, pollution, and costs resulting from heating and cooling buildings, manufacturers and consumers of heating and cooling systems have placed a greater focus on energy conservation. For example, some users may attempt to limit their personal use of air conditioning or furnace systems. Additionally, some thermostats allow users to input different desired temperature settings for different time periods on specific days (e.g., when in a heating mode allowing the user to set a lower desired temperature setting for hours the user is at work) in order to reduce the overall operational time of their environmental system.

Further, the U.S. Department of Energy implemented the Seasonal Energy Efficiency Ratio (SEER) in order to regulate energy consumption by air conditioners. For at least these reasons, systems and methods which reduce the energy consumption required to control the heating, cooling, and humidity levels of confined spaces are important for decreasing energy demand, pollution, and consumer energy costs.

As such, there are opportunities to develop an improved environmental control system and method that can automatically adjust one or more operating parameters of the heating, cooling, and other related systems.

### SUMMARY

Advantages are achieved by the present environmental control system or method which includes various modules and a database for storing specific control instructions relating to adjustment of corresponding operating parameters of environmental systems, such as cooling, heating and humidity control systems. The present environmental control system further includes a computer processor coupled to databases and programmed to perform particular tasks and display relational information of the operating parameters.

As discussed in greater detail below, the present environmental control system provides an enhanced control function for adjusting the operating parameters using various modules and other related systems. In one embodiment, it is contemplated that the present environmental control system and method is provided for automatically monitoring and adjusting the operating parameters.

Also included in the present disclosure is a system and method configured for monitoring patterns of operating parameter variations during a predetermined time period based on historical information of a comparative logic or algorithm. Further, the present environmental control system provides enhanced displays and relations of the operating parameters in real time. Additionally, the operating parameters are adjusted and regulated automatically without substantial manual interruptions. As a result, the overall operational time of the environmental systems is reduced and thus related operating expenses and energy consumption rates are decreased.

In one embodiment, the present environmental control system is connected to a weather forecast system, and measures a rate of cooling or heating as well as humidification and dehumidification rates of a controlled space when the system is in either an idle mode or an operation mode. Based on an outside temperature forecast, an inside temperature and an inside humidity level are calculated. For example, the inside temperature and the inside humidity level for the next predetermined number of hours are calculated based on the outside temperature forecast to decide an exact time for the present control system to initiate the cooling or heating operation. Pre-cooling or pre-heating operation is initiated prior to a peak energy start time if a target space is occupied. If the temperatures in different locations belonging to the same control system are different by a predetermined threshold, the present system starts a fan unit or keeps the fan unit on for a predetermined time period.

It is contemplated that, except during a peak energy mode or an away mode, if the temperature is increasing at a rate faster than the rate at which cooling of the target space can occur, the system starts the cooling operation. Similarly, except during a peak energy mode or an away mode, if the temperature is decreasing at a rate faster than the rate at which heating of the target space can occur, the system starts the heating operation. Except during a peak energy or away mode, the cooling operation starts at a set point plus a high tolerance, and continues till the set point is reached, and then continues to a low tolerance only if the humidity level is higher than a predetermined threshold after reaching the set point or during a pre-cool operation. Similarly, except during a peak energy or away mode, the heating operation starts at a low tolerance below the set point and continues till the set point is reached, and then continues to a high tolerance only for pre-heating operation.

Prior to the start of the peak energy mode and prior to the finish of away mode, the system performs the heating operation for the target space until the set point is reached. The heating operation is performed until a temperature high tolerance is reached, if a time duration of the peak energy mode causes an internal temperature drop which is more than or equal to a value of (a temperature high tolerance−a temperature low tolerance). The time to start heating is determined based on the indoor temperature and the rate of heating which is possible with the heating on. Prior to the start of the peak energy mode and prior to the finish of away mode the system performs the cooling operation for the target space until the set point is reached. The cooling is performed until a temperature low tolerance is reached, (other than for controlling the humidity level), if the time duration of the peak energy mode causes an internal temperature rise which is more than or equal to a value of (a temperature high tolerance−a temperature low tolerance). The time to start cooling is determined based on the indoor temperature and the rate of cooling which is possible with the cooling on.

In one embodiment, if the humidity level is lower than a predetermined threshold, a humidifier is operated along with a fan unit. In an auto heat/cool mode, if the temperature low tolerance is reached by cooling, the heating operation does not start for a predetermined period (e.g., 30 min) and if the current temperature is more than one degree (e.g., ° F. or ° C.) below a temperature low tolerance, unless the rate of cooling in an off mode is faster than the rate of heating possible in the heat on mode, or the current temperature has fallen below the low tolerance by a predetermined threshold (e.g., 3 degrees). The auto heat/cool mode determines between heating and cooling operations based on whether the current temperature is rising or falling when the system is idle. The present system also determined the indoor conditions of the target space for the next predetermined number of hours (e.g., 12 hours) based on the outside temperature and weather forecast.

In one embodiment of the present disclosure, an environmental control system is provided, and includes an interface module configured to provide an interface associated with the environmental control system for controlling operation of a network connected to the environmental control system and receiving operating data from at least one sensor associated with a target space. A monitoring module is configured to receive the operating data via the interface module and provide environmental condition information about the target space. A detection module is configured to examine the operating data for controlling at least one environmental unit, to recognize an environmental condition change and identify a triggering event defined by a difference between at least two operating parameters of the environmental control system, and to determine a desired environmental operation based on the difference. An adjustment module is configured to adjust at least one operating parameter of the at least one environmental unit associated with the target space in response to the triggering event identified by the detection module.

In one example, the interface module includes a gateway unit configured to provide a set of wireless routing rules supporting a communication technique via the network. In a variation, the gateway unit is an initial node in the network configured for providing one or more connections between neighboring nodes in the network. In another variation, the gateway unit communicates with a routing unit configured to be an interface computing device having an adaptive module configured for transferring messages between a server and a node in the network. In yet another variation, the routing unit is configured to send and receive the messages in at least one data packet in the network between the environmental control system and at least one neighboring node in the network.

In another example, the monitoring module is configured to provide the environmental condition information related to at least one of: interior and exterior environmental conditions of the target space.

In yet another example, the at least one environmental unit includes at least one of: a cooling unit, a heating unit, a humidity unit, and a fan unit.

In still another example, the at least two operating parameters of the environmental control system includes a first parameter associated with a temperature operation and a second parameter associated with a humidity operation.

In yet still another example, the environmental control system can include an alert module configured to inform a user of the triggering event and provide an option to change the triggering event by adjusting the at least one operating parameter related to the target space.

In a further example, the environmental control system can include a display module configured to interactively display an information message associated with the triggering event on a display device.

In another embodiment of the present disclosure, a method of operating an environmental control system is provided. The method includes providing an interface associated with the environmental control system for controlling operation of a network connected to the environmental control system; receiving operating data from at least one sensor associated with a target space; receiving the operating data via the interface module, and providing environmental condition information about the target space; examining the operating data for controlling at least one environmental unit; recognizing an environmental condition change and identifying a triggering event defined by a difference between at least two operating parameters of the environmental control system; determining a desired environmental operation based on the difference; and adjusting at least one operating parameter of the at least one environmental unit associated with the target space in response to the triggering event identified by the detection module.

In one example, the method further includes providing a set of wireless routing rules supporting a communication technique via the network. In a variation, the method further includes providing an initial node in the network configured for providing one or more connections between neighboring nodes in the network. In a further variation, the method further includes communicating with a routing unit configured to be an interface computing device having an adaptive module configured for transferring messages between a server and a node in the network. In a yet further variation, the method further includes sending and receiving the messages in at least one data packet in the network between the environmental control system and at least one neighboring node in the network.

In another example, the method further includes providing the environmental condition information related to at least one of: interior and exterior environmental conditions of the target space.

In yet another example, the method further includes including, as the at least one environmental unit, at least one of: a cooling unit, a heating unit, a humidity unit, and a fan unit.

In still another example, the method further includes including, as the at least two operating parameters of the environmental control system, a first parameter associated with a temperature operation and a second parameter associated with a humidity operation.

In yet still another example, the method further includes informing a user of the triggering event and providing an option to change the triggering event by adjusting the at least one operating parameter related to the target space.

In a further example, the method further includes interactively displaying an information message associated with the triggering event on a display device.

Additional features and advantages of the present disclosure will become apparent to those skilled in the art upon consideration of the following detailed description of the illustrative embodiment exemplifying the best mode of carrying out the present disclosure as presently perceived.

### BRIEF DESCRIPTION OF THE DRAWINGS

The embodiments will be more readily understood in view of the following description when accompanied by the below figures and wherein like reference numerals represent like elements, wherein:

FIG. 1 is a conceptual diagram of the present environmental control system featuring a central control module;

FIG. 2 is a functional block diagram of the present environmental control system, featuring children modules of the central control module of FIG. 1;

FIG. 2A is a functional block diagram of the present environmental control system, featuring an exemplary network topology used by the central control module of FIG. 1;

FIG. 3A is a flow chart of an exemplary method of executing the present environmental control system;

FIG. 3B is a flow chart of an exemplary method of executing the heating operation of the present environmental control system; and

FIG. 3C is a flow chart of an exemplary method of executing the cooling operation of the present environmental control system.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF EMBODIMENTS

Embodiments of the present disclosure are described below by way of example only, with reference to the accompanying drawings. Further, the following description is merely exemplary in nature and is in no way intended to limit the disclosure, its application, or uses. As used herein, the term “module” or “unit” may refer to, be part of, or include an Application Specific Integrated Circuit (ASIC), an electronic circuit, a processor or microprocessor (shared, dedicated, or group) and/or memory (shared, dedicated, or group) that executes one or more software or firmware programs, a combinational logic circuit, and/or other suitable components that provide the described functionality. Thus, while this disclosure includes particular examples and arrangements of the modules, the scope of the present system should not be so limited since other modifications will become apparent to the skilled practitioner.

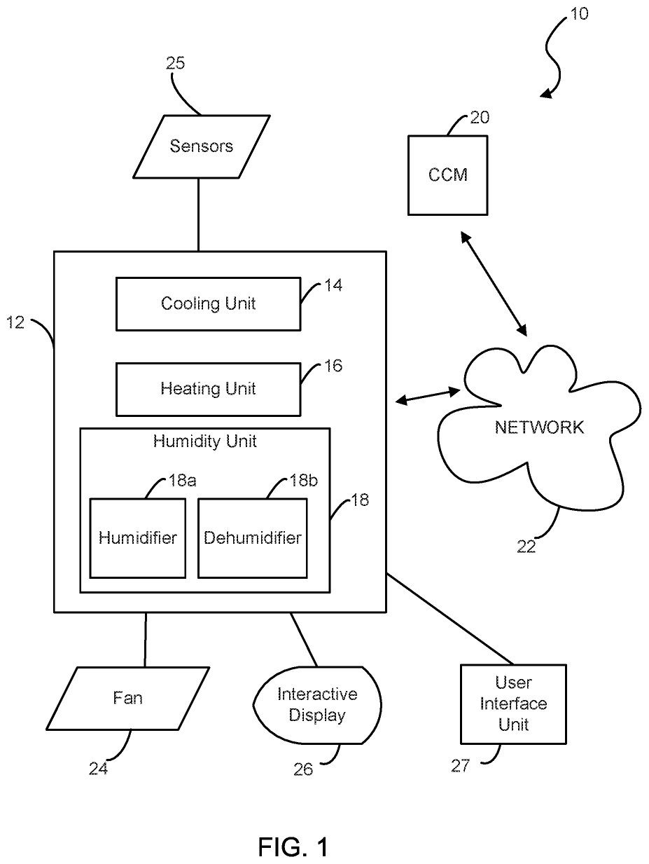

Referring now to FIG. 1, the present environmental control system is generally designated 10, and is designed to provide an efficient way to control one or more environmental systems 12 having at least one of a cooling unit 14, a heating unit 16, and a humidity unit 18. It is contemplated that the humidity unit 18 includes a humidifier 18a and/or a dehumidifier 18b, as desired. While a combination of both the humidifier 18a and the dehumidifier 18b is shown for illustration purposes, other arrangements are also contemplated, such as a separate humidifier or dehumidifier unit, to suit the application.

More specifically, the present control system 10 includes a central control module or unit (CCM) 20, which regulates an overall operation of the present system. In general, the CCM 20 monitors at least one of the cooling unit 14, the heating unit 16, and the humidity unit 18 for controlling corresponding operating parameters of the respective environmental system 12 via a network 22.

Any type of computer network having a collection of computers, servers, and other hardware interconnected by communication channels is contemplated, such as the Internet, Intranet, Ethernet, LAN, etc. In one embodiment, the CCM 20 interfaces with the network 22, such as by using a wired or wireless communication device (e.g., a Wi-Fi access point), and performs control operations for the environmental system 12. Other similar networks known in the art are also contemplated.

It is contemplated that each environmental system 12 includes a fan unit 24 connected to the present control system 10 and configured for circulating a fluid, such as air or liquid, throughout the environmental system, as desired. An exemplary fan unit includes a low blower or ventilator having a centrifugal multi-blade component for delivering air to a target space of a building structure. Other suitable fan units are contemplated to suit different applications.

It is contemplated that the fan unit 24 operates in an on mode, an auto mode, or a circulation mode. When in the on mode, the fan unit 24 is always powered on, and when in the auto mode, the fan unit is powered on with a heating/cooling/humidification or dehumidification operation option. After the heating/cooling/dehumidification/humidification operation, the fan unit 24 optionally remains powered on for a predetermined time period (e.g., 5 minutes) in the auto mode. In the circulation mode, the fan unit 24 operates similar to the auto mode, but when at least one of the cooling unit 14, the heating unit 16, the humidifier 18a, and the dehumidifier 18b is idle, the fan unit 24 is activated for the predetermined time period (e.g., 5 minutes) at every 15-minute interval to improve circulation of the target space. It is contemplated that the circulation mode is selectively activated during a peak energy time period.

Also included in the environmental system 12 are one or more sensors 25, such as a temperature sensor, a humidity sensor, and the like, disposed inside or outside of a target space in a building structure, and configured for measuring interior or exterior environmental conditions relative to the target space.

During operation, related information of the operating parameters is displayed on an interactive display 26 accessible to a user. The CCM 20 manages interactions between the user and the present system 10 by way of a human machine interface (HMI), such as a keyboard, a touch sensitive pad or screen, a mouse, a trackball, a voice recognition system, and the like. The interactive display 26 (e.g., textual and graphical) is configured for receiving input data from the user and/or the CCM 20.

In one embodiment, the user uses an input device, such as the HMI, to graphically or textually interact with the present system 10. Associated data and/or parameters are generally received in the CCM 20 and then transferred to the display 26 via a dedicated or shared communication system. Further, any collaborative other and third-party database reachable by the CCM 20 can also be used for the environmental control system 10.

In another embodiment, a user interface unit 27 is communicably coupled to the environmental system 12 for wirelessly or non-wirelessly communicating data between the user interface unit 27 and the CCM 20 via the network 22. It is contemplated that the user interface unit 27 may be a computer application hardware included in a mobile device, such as a cellular phone or tablet, having computer-executable instructions configured to receive signals from the sensors 25 and execute the instructions related to heating and cooling operations of the environmental system 12.

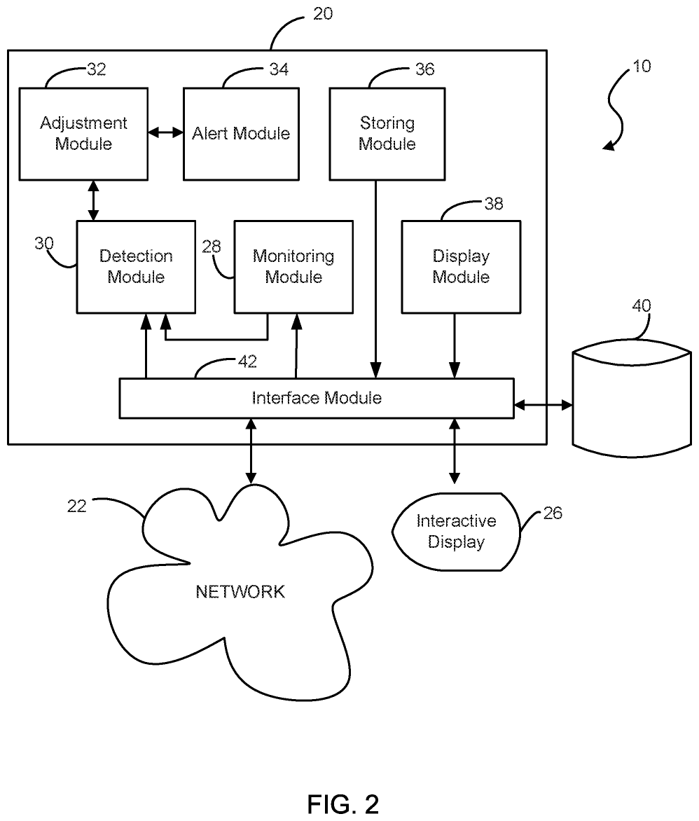

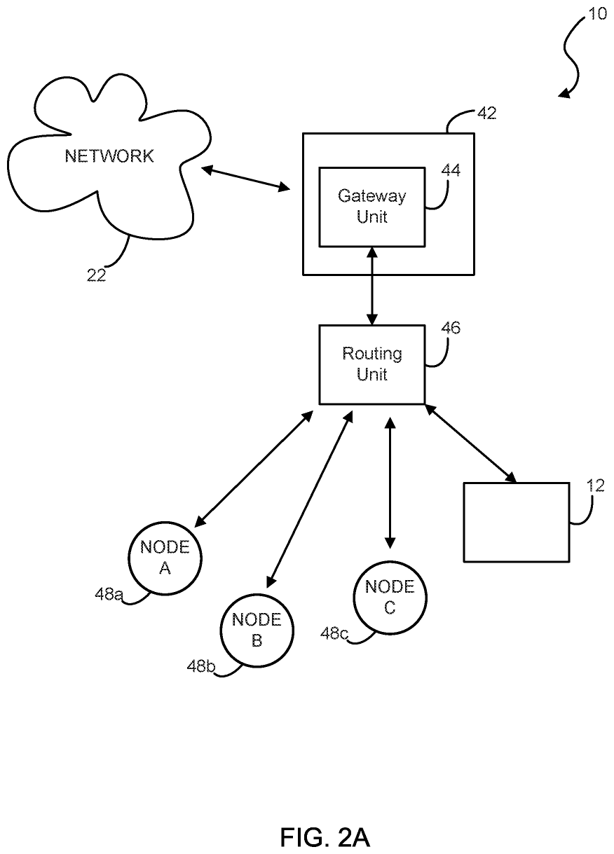

Referring now to FIGS. 1 and 2, in one embodiment, the present environmental control system 10 includes the CCM 20 having a monitoring module 28, a detection module 30, an adjustment module 32, an alert module 34, a storing module 36, and a display module 38. Although these sub-modules 28, 30, 32, 34, 36, 38 are illustrated as children modules subordinate of the parent module CCM 20, each sub-module can be operated as a separate unit from the CCM, and other suitable combinations of sub-modules are contemplated to suit different applications. One or more modules or units can be selectively bundled as a key software model running on the processor having software as a service (SSaS) features.

All relevant information can be stored in a central database 40, e.g., as a non-transitory data storage device and/or a machine readable data storage medium carrying computer-executable instructions, for retrieval by the CCM 20 and its children modules. Also included in the CCM 20 is an interface module 42 for providing an interface between the CCM 20, the central database 40, the network 22, and the display 26. The interface module 42 controls operation of, for example, the network 22, the display 26, and other related system devices, services, and applications. The other devices, services, and applications may include, but are not limited to, one or more software or hardware components, etc., related to the CCM 20. The interface module 42 also receives operating data or parameters from the sensors 25 or the related systems, which are communicated to the respective modules, such as the CCM 20, and its children modules.

Referring now to FIG. 2A, in one embodiment, the present environmental control system 10 utilizes a network topology for relaying or communicating messages and/or related data between the environmental system 12 and the CCM 20 via the network 22 according to a set of predetermined routing rules. In one embodiment, the interface module 42 includes a gateway unit 44 configured to provide a set of wireless routing rules supporting communication techniques via the network 22. The gateway unit 44 acts as an initial node in the network 22 configured for providing one or more connections between neighboring nodes using a routing unit 46. It is contemplated that the routing unit 46 is an interface computing device having an adaptive module configured for transferring the messages and/or related data between a networked server and a node in the network 22. Exemplary networks include, but are not limited to, a wide-area network, a local-area network, a wireless personal area network, and the like. Although the interface module 42 having the gateway unit 44 is shown, a different configuration, such as an independent, separate gateway unit, is also contemplated.

In one embodiment, the routing unit 46 is configured to send and receive the messages and/or related data in multiple data packets in the network 22 between the environmental system 12 and at least one neighboring node, namely NODE A 48a, NODE B 48b, NODE C 48c. During operation, the nodes 48a, 48b, 48c may act as interoperable sleepy end nodes in a predetermined network layer of the network 22, and may communicate with each other for sharing information associated with the messages and/or related data. Exemplary sleepy end nodes include, but are not limited to, a light sensor, a humidity sensor, a temperature sensor, and the like. Further, the routing unit 46 may communicate with one or more other routers in the network 22, and the environmental system 12. Other suitable network topology techniques are contemplated to suit different applications.

Returning to FIG. 2, the monitoring module 28 is configured to receive the operating data and parameters via the interface module 42, and provide environmental condition or status information about the target space of the building structure. Specifically, the monitoring module 28 provides detailed information of the interior and/or exterior environmental conditions, such as temperature and humidity, relative to the target space in the building structure using the sensors 25. In general, as discussed in greater detail below, the present system 10 assesses its operational status by evaluating the environmental conditions.

In a regular mode, the monitoring module 28 initially sets a temperature set-point T_{SP}, a temperature high tolerance T_{HT} that is greater than the temperature set-point T_{SP}, and a temperature low tolerance T_{LT} that is less than the temperature set-point T_{SP}. Further, a humidity set-point H_{SP}, a humidity high tolerance H_{HT}, and a humidity low tolerance H_{LT} are set by the monitoring module 28. A minimum difference between the humidity set-point H_{SP} and the humidity high tolerance H_{HT} is approximately 5%, and the minimum difference between the humidity set-point H_{SP} and the humidity low tolerance H_{LT} is also approximately 5%, although in certain embodiments the percentage could be higher or lower. The humidity high tolerance H_{HT} is greater than the humidity set-point H_{SP}, and the humidity low tolerance H_{LT} is less than the humidity set-point H_{SP}. When a first rate at which a current temperature of the target space is rising (e.g., 1° F./minute) is greater than a second rate at which the environmental system 12 achieves cooling at a predetermined delta temperature between an interior temperature and an exterior temperature (e.g., −1° F./6 minutes), the cooling operation is initiated by the CCM 20.

In a peak energy or away mode, the monitoring module 28 sets a heating temperature set-point HT_{SP} and a cooling temperature set-point CT_{SP}. The heating temperature set-point HT_{SP} is less than the cooling temperature set-point CT_{SP}. During the peak energy or away mode, when the environmental system 12 is idle and if the interior temperature T_{IN} is rising, the CCM 20 may initiate the cooling operation. The cooling operation is initiated only when the interior temperature T_{IN} reaches the temperature high tolerance T_{HT}, and the cooling operation continues until the cooling temperature set-point CT_{SP} is reached.

The heating operation is performed in a similar fashion to reach the heating temperature set-point HT_{SP}. For example, during the peak energy or away mode, when the environmental system 12 is idle and if the interior temperature T_{IN} is falling, the CCM 20 may initiate the heating operation. The heating operation is initiated only when the interior temperature T_{IN} reaches the temperature low tolerance T_{LT}, or when the rate of temperature drop is greater than the rate at which the environmental system 12 can achieve desired heating for the target space, and the heating operation continues until the heating temperature set-point HT_{SP} is reached.

As such, the environmental system 12 performs heating and cooling operations to bring an ambient temperature of the target space in the building structure as closely as possible to the temperature set-point T_{SP} with a predetermined hysteresis range.

The detection module 30 is configured to receive the operating data and parameters from the network 22 via the interface module 42, and to examine the received operating data and parameters for controlling at least one of the units 14, 16, 18, 24 based on a predetermined set of rules or algorithms. During operation, the detection module 30 recognizes an environmental condition change and identifies a triggering event based on a predetermined analysis in communication with the database 40.

For example, the triggering event is defined by a difference between at least two operating parameters of the environmental system 12, including the temperature and humidity set-point T_{SP}, H_{SP}, the temperature high or low tolerance T_{HT}, T_{LT}, and the humidity high or low tolerance H_{HT}, H_{LT}. Further, an indoor or interior temperature T_{IN} of the target space, an outdoor or exterior temperature T_{OUT} of the target space, an indoor or interior humidity H_{IN} of the target space, and an outdoor or exterior humidity H_{OUT} of the target space are also included in the operating parameters.

While the environmental system 12 is operating at the temperature set-point T_{SP}, or the heating or cooling unit 14, 16 is idle, the detection module 30 determines whether the cooling or heating operation is desired based on a difference between the indoor or interior temperature T_{IN} of the target space and the temperature high or low tolerance T_{HT}, T_{LT}. For example, when the interior temperature T_{IN} rises and becomes greater than the temperature high tolerance T_{HT}, the cooling operation is initiated by the detection module 30. The heating operation is similarly initiated.

Further, the detection module 30 initiates the humidity operation based on a difference between the indoor or interior humidity H_{IN} of the target space and the humidity high or low tolerance H_{HT}, H_{LT}. For example, when the interior humidity H_{IN} rises and becomes greater than the humidity high tolerance H_{HT}, the dehumidifying operation is initiated by the detection module 30 by activating the dehumidifier 18b. The humidifying operation is similarly initiated. Thus, the detection module 30 activates the humidifier 18a and the fan unit 24 to increase the interior humidity H_{IN}, or activates the dehumidifier 18b and the fan unit to decrease the interior humidity, as desired.

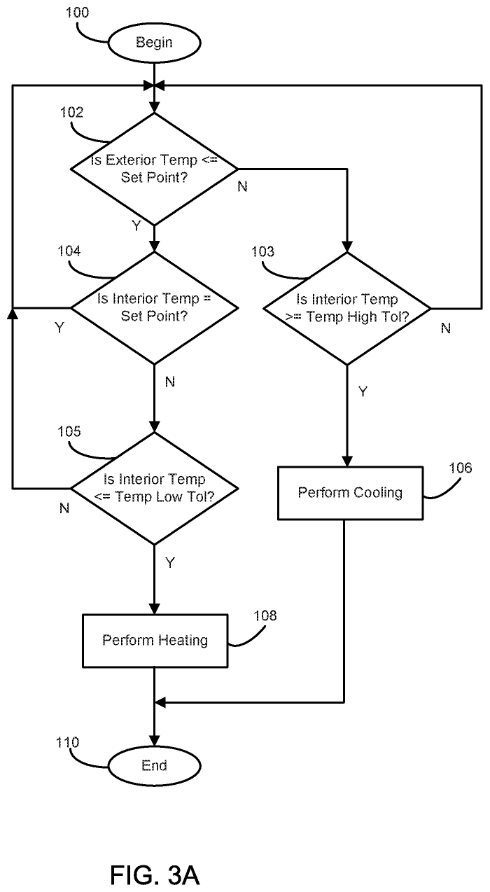

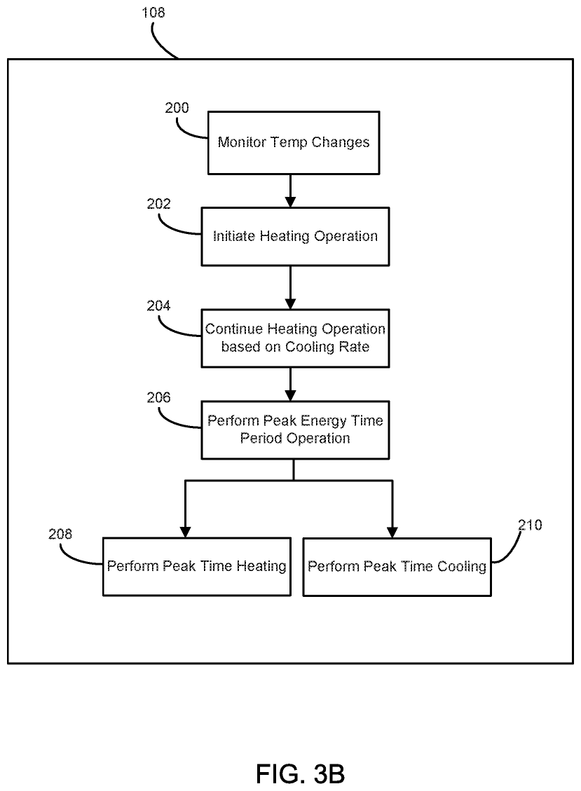

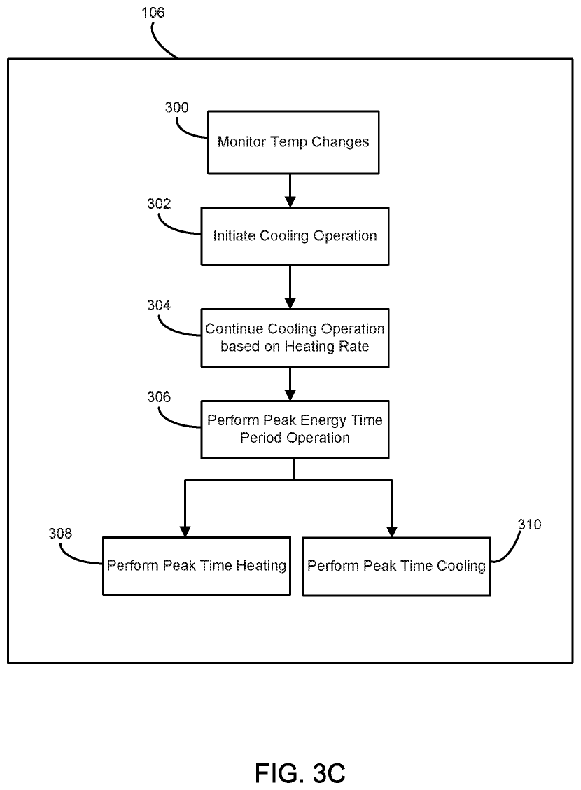

The adjustment module 32 is configured to adjust or modify at least one operating parameter of the environmental system 12 in response to the triggering event identified by the detection module 30. In one embodiment, the adjustment module 32 evaluates each identified triggering event by applying a set of predetermined algorithms. Exemplary algorithms are described in paragraphs relating to FIGS. 3A-3C. When the adjustment module 32 determines that the triggering event is valid, the adjustment module automatically performs an adjustment task to control the environmental system 12. The adjustment task generally refers to calculations and modifications of the operating parameters related to the CCM 20.

Typically, the cooling operation can cause dehumidification and a rate of dehumidification can depend on the efficiency of the environmental system 12. Thus, when the cooling operation is initiated by the detection module 30, the adjustment module 32 determines a rate of dehumidification RDHC as a humidity decrease percentage (%) per temperature degree cooled during the cooling operation. For example, the cooling and dehumidifying operation can occur simultaneously when the humidity difference between a current interior humidity H_{IN} and the humidity set-point H_{SP} is greater than a value of ((a current interior temperature T_{IN}−the temperature set-point T_{SP})*the rate of dehumidification RDHC).

If the environmental system 12 is not equipped with the dehumidifier 18b, the adjustment module 32 calculates a first future humidity FH1, when the interior temperature T_{IN} reaches the temperature set-point T_{SP}, as (the current interior humidity H_{IN}−((the current interior temperature T_{IN}−the temperature set-point T_{SP})*(the rate of dehumidification RDHC))).

If the first future humidity FH1 is greater than the humidity high tolerance H_{HT} and the environmental system 12 is equipped with the fan unit 24, the cooling operation is activated with a first predetermined fan speed to achieve enhanced dehumidification. A rate of dehumidification while cooling at the first predetermined fan speed RDHC_{FAN} is calculated by the adjustment module 32 as a humidity decrease percentage (%) per temperature degree cooled during the cooling operation.

The adjustment module 32 calculates a second future humidity FH2, when the interior temperature T_{IN} reaches the temperature set-point T_{SP}, as (the current interior humidity H_{IN}−((the current interior temperature T_{IN}−the temperature set-point T_{SP})*(the rate of dehumidification while cooling at the first predetermined fan speed RDHC_{FAN}))).

If the second future humidity FH2 is greater than the humidity high tolerance H_{HT}, the adjustment module 32 calculates a third future humidity FH3, when the interior temperature T_{IN} reaches the temperature low tolerance T_{LT}, as (the current interior humidity H_{IN}−((the current interior temperature T_{IN}−the temperature low tolerance T_{LT})*(the rate of dehumidification while cooling at the first predetermined fan speed RDHC_{FAN}))).

If the third future humidity FH3 is greater than the humidity high tolerance H_{HT}, the adjustment module 32 initiates the alert module 34 to inform the user that, with the current environmental system 12, the interior humidity H_{IN} will be at the third future humidity FH3 even when the target space is cooled to the temperature low tolerance T_{LT}, and the cooling operation continues at the first predetermined fan speed until the temperature low tolerance T_{LT} is reached.

However, if the first future humidity FH1 is greater than the humidity high tolerance H_{HT} and the environmental system 12 is not equipped with the fan unit 24, the adjustment module 32 calculates a fourth future humidity FH4, when the interior temperature T_{IN} reaches the temperature low tolerance T_{LT}, as (the current interior humidity H_{IN}−((the current interior temperature T_{IN}−the temperature low tolerance T_{LT})*(the rate of dehumidification RDHC))).

If the fourth future humidity FH4 is greater than the humidity high tolerance H_{HT}, the adjustment module 32 initiates the alert module 34 to inform the user that, with the current environmental system 12, the interior humidity H_{IN} will be at the fourth future humidity FH4 even when the target space is cooled to the temperature low tolerance T_{LT}, and the cooling operation continues at a second predetermined fan speed until the temperature low tolerance T_{LT} is reached. The second predetermined fan speed is faster than the first predetermined fan speed. At the first predetermined fan speed, the rate of dehumidification is faster than the rate of dehumidification at the second predetermined fan speed.

Further, the alert module 34 is configured to inform the user or other users of the detected triggering event. One or more warning messages may be sent by the alert module 34 to a mobile device or any other computing device to alert the user or other users. It is also contemplated that when the triggering event is detected, the alert module 34 provides an option to change or override the triggering event by adjusting one or more operating parameters related to the target space.

The storing module 36 is configured to control and digitally store relevant information related to the present control system 10 in the central database 40. More specifically, the central database 40 includes operating data and parameters related to analysis data about the triggering events for the purposes of research, development, improvement of the comparative logic or algorithms and further investigations by the user or the related systems.

The display module 38 is configured to interactively display an appropriate status or information message associated with the triggering event for illustration on the interactive display 26. An instance report related to each triggering event is generated by the display module 38, and also automatically transmitted to a central server or other systems, as desired.

Referring now to FIGS. 3A-3C, an exemplary method or process of executing the present environmental control system 10 is illustrated. Although the following steps are primarily described with respect to the embodiments of FIGS. 1-2A, it should be understood that the steps within the method may be modified and executed in a different order or sequence without altering the principles of the present disclosure.

In FIG. 3A, the method begins at step 100. In step 102, the monitoring module 28 determines whether the exterior temperature T_{OUT} is less than or equal to the temperature set-point T_{SP}. If so, control proceeds to step 104, otherwise control proceeds to step 103. In step 103, the monitoring module 28 determines whether the interior temperature T_{IN} is greater than or equal to the temperature high tolerance T_{HT}. If so, control proceeds to step 106. Otherwise, control returns to step 102. In step 104, when the interior temperature T_{IN} is equal to the temperature set-point T_{SP}, control returns to step 102, otherwise control proceeds to step 105. In step 105, the monitoring module 28 determines whether the interior temperature T_{IN} is less than or equal to the temperature low tolerance T_{LT}. If so, control proceeds to step 108. Otherwise, control returns to step 102. In step 106, the CCM 20 initiates the cooling operation. In step 108, the CCM 20 initiates the heating operation. The method ends at step 110 which may include a return to step 102.

FIG. 3B shows an exemplary heating operation. In step 200, the monitoring module 28 determines whether the interior temperature T_{IN} is less than the temperature low tolerance T_{LT}, and monitors a future temperature set-point T_{SP} change, a future exterior temperature T_{OUT} change, a future peak energy or away mode change, and whether the interior temperature T_{IN} is greater than the temperature high tolerance T_{HT}. In step 202, if the interior temperature T_{IN} is less than the temperature low tolerance T_{LT}, or if the future exterior temperature T_{OUT} within a predetermined time period (e.g., in next 10 hours) is less than a current exterior temperature T_{OUT} or if a future temperature set-point T_{SP} within the predetermined time period is greater than a current temperature set-point T_{SP}, the heating operation is initiated and continues until the temperature set-point T_{SP} or the temperature high tolerance T_{HT} is reached depending on the application.

In step 204, if the future exterior temperature T_{OUT} is greater than the current temperature low tolerance T_{LT}, or if the future temperature set-point T_{SP} is less than the current temperature set-point T_{SP}, the adjustment module 32 calculates a rate of cooling with the current environmental system 12 in the idle mode by using a temperature difference between the current interior temperature T_{IN} and the current exterior temperature T_{OUT}, and calculates a degree of temperature drop T_{DROP} in the target space by the time the exterior temperature T_{OUT} becomes greater than the current temperature low tolerance T_{LT}. Then, the heating operation is continued by setting the temperature set-point T_{SP} to a value of (the current temperature low tolerance T_{LT}+the temperature drop T_{DROP}).

In step 206, when a peak energy time period is expected in a predetermined time period (e.g., in next 10 hours), the monitoring module 28 monitors a duration of the peak energy time period TP1. Using a first temperature difference between the future exterior temperature T_{OUT} and a peak-period temperature set-point peak-T_{SP} at the beginning of the peak energy time period, the adjustment module 32 calculates a first cooling rate CRa (if the temperature difference is negative) or calculates a first heating rate HRa (if the temperature difference is positive) when the environmental system 12 is operating in the idle mode. The peak-period temperature set-point peak-T_{SP} may include separate peak temperature set-points for cooling or heating.

Using a second temperature difference between the future exterior temperature T_{OUT} and the peak-period temperature set-point peak-T_{SP} at the end of the peak energy time period, the adjustment module 32 calculates a second cooling rate CRb (if the temperature difference is negative) or calculates a second heating rate HRb (if the temperature difference is positive) when the environmental system 12 is operating in the idle mode.

In step 208, the first and second cooling rates CRa, CRb are initialized to zero, and using the first cooling rate CRa and the peak energy time period TP1, the adjustment module 32 calculates the degree of temperature drop peak-T_{DROP} in the target space during the peak energy time period TP1. When a sum of a peak-period temperature low tolerance peak-T_{LT} and the degree of temperature drop peak-T_{DROP} is greater than a peak-period temperature high tolerance peak-T_{HT}, the alert module 34 informs the user by issuing a warning message stating that “SYSTEM MAY COME ON DURING PEAK IF NOT PRE-HEATED TO (peak-T_{LT}+peak-T_{DROP}) OR (peak-T_{HT}−peak-T_{DROP}).” Any of the operating parameters, such as the peak-T_{LT} or peak-T_{HT}, are selectively modifiable by the adjustment module 32, as desired.

Using a third temperature difference between the peak-period temperature high tolerance peak-T_{HT} and the exterior temperature T_{OUT} at the beginning of the peak energy time period, the adjustment module 32 calculates a heating rate with the heating unit 16 turned-on and a time period TP_{REACH} for reaching the peak-period temperature set-point peak-T_{SP} at the beginning of the peak energy time period. The heating operation starts at the time period T_{PREACH} before the beginning of the peak energy time period until the interior temperature T_{IN} reaches the peak-period temperature set-point peak-T_{SP} for the heating operation.

In step 210, the first and second heating rates HRa, HRb are initialized to zero, and using the first heating rate HRa and the peak energy time period TP1, the adjustment module 32 calculates the degree of temperature rise peak-T_{RISE} in the target space during the peak energy time period TP1. When a sum of a peak-period temperature high tolerance peak-T_{HT} and the degree of temperature rise peak-T_{RISE} is greater than a peak-period temperature low tolerance peak-T_{LT}, the alert module 34 informs the user by issuing a warning message stating that “SYSTEM MAY COME ON DURING PEAK IF NOT PRE-COOLED TO (peak-T_{HT}−peak-T_{RISE}) OR (peak-T_{LT}+peak-T_{RISE}).” Any of the operating parameters, such as the peak-T_{LT} or peak-T_{HT}, are selectively modifiable by the adjustment module 32, as desired.

Using a fourth temperature difference between the peak-period temperature low tolerance peak-T_{LT} and the exterior temperature T_{OUT} at the beginning of the peak energy time period, the adjustment module 32 calculates a cooling rate with the cooling unit 14 turned-on and a time period TP_{REACH} for reaching the peak-period temperature set-point peak-T_{SP} at the beginning of the peak energy time period. The cooling operation starts at the time period T_{PREACH} before the beginning of the peak energy time period until the interior temperature T_{IN} reaches the peak-period temperature set-point peak-T_{SP} for the cooling operation.

FIG. 3C shows an exemplary cooling operation. In step 300, the monitoring module 28 determines whether the interior temperature T_{IN} is greater than the temperature high tolerance T_{HT}, and monitors a future temperature set-point T_{SP} change, a future exterior temperature T_{OUT} change, a future peak energy or away mode change, and whether the interior temperature T_{IN} is less than the temperature low tolerance T_{LT}. In step 302, if the interior temperature T_{IN} is greater than the temperature high tolerance T_{HT}, or if the future exterior temperature T_{OUT} within a predetermined time period (e.g., in next 10 hours) is greater than a current exterior temperature T_{OUT} or if a future temperature set-point T_{SP} within the predetermined time period is less than a current temperature set-point T_{SP}, the cooling operation is initiated and continues until the temperature set-point T_{SP} or the temperature low tolerance T_{LT} is reached depending on the application.

In step 304, if the future exterior temperature T_{OUT} is less than the current temperature high tolerance T_{HT}, or if the future temperature set-point T_{SP} is greater than the current temperature set-point T_{SP}, the adjustment module 32 calculates a rate of heating with the current environmental system 12 in the idle mode by using a temperature difference between the current interior temperature T_{IN} and the current exterior temperature T_{OUT}, and calculates a degree of temperature rise T_{RISE} in the target space by the time the exterior temperature T_{OUT} becomes less than the current temperature high tolerance T_{HT}. Then, the cooling operation is continued by setting the temperature set-point T_{SP} to a value of (the current temperature high tolerance T_{HT}−the temperature rise T_{RISE}).

In step 306, when a peak energy time period is expected in a predetermined time period (e.g., in next 10 hours), the monitoring module 28 monitors a duration of the peak energy time period TP1. Using a first temperature difference between the future exterior temperature T_{OUT} and a peak-period temperature set-point peak-T_{SP} at the beginning of the peak energy time period, the adjustment module 32 calculates a first cooling rate CRa (if the temperature difference is negative) or calculates a first heating rate HRa (if the temperature difference is positive) when the environmental system 12 is operating in the idle mode. The peak-period temperature set-point peak-T_{SP} may include separate peak temperature set-points for cooling or heating.

Using a second temperature difference between the future exterior temperature T_{OUT} and the peak-period temperature set-point peak-T_{SP} at the end of the peak energy time period, the adjustment module 32 calculates a second cooling rate CRb (if the temperature difference is negative) or calculates a second heating rate HRb (if the temperature difference is positive) when the environmental system 12 is operating in the idle mode.

In step 308, the first and second cooling rates CRa, CRb are initialized to zero, and using the first cooling rate CRa and the peak energy time period TP1, the adjustment module 32 calculates the degree of temperature drop peak-T_{DROP} in the target space during the peak energy time period TP1. When a sum of a peak-period temperature low tolerance peak-T_{LT} and the degree of temperature drop peak-T_{DROP} is greater than a peak-period temperature high tolerance peak-T_{HT}, the alert module 34 informs the user by issuing a warning message stating that “SYSTEM MAY COME ON DURING PEAK IF NOT PRE-HEATED TO (peak-T_{LT}+peak-T_{DROP}) OR (peak-T_{HT}−peak-T_{DROP}).” Any of the operating parameters, such as the peak-T_{LT} or peak-T_{HT}, are selectively modifiable by the adjustment module 32, as desired.

Using a third temperature difference between the peak-period temperature high tolerance peak-T_{HT} and the exterior temperature T_{OUT} at the beginning of the peak energy time period, the adjustment module 32 calculates a heating rate with the heating unit 16 turned-on and a time period TP_{REACH} for reaching the peak-period temperature set-point peak-T_{SP} at the beginning of the peak energy time period. The heating operation starts at the time period T_{PREACH} before the beginning of the peak energy time period until the interior temperature T_{IN} reaches the peak-period temperature set-point peak-T_{SP} for the heating operation.

In step 310, the first and second heating rates HRa, HRb are initialized to zero, and using the first heating rate HRa and the peak energy time period TP1, the adjustment module 32 calculates the degree of temperature rise peak-T_{RISE} in the target space during the peak energy time period TP1. When a sum of a peak-period temperature high tolerance peak-T_{HT} and the degree of temperature rise peak-T_{RISE} is greater than a peak-period temperature low tolerance peak-T_{LT}, the alert module 34 informs the user by issuing a warning message stating that “SYSTEM MAY COME ON DURING PEAK IF NOT PRE-COOLED TO (peak-T_{HT}−peak-T_{RISE}) OR (peak-T_{LT}+peak-T_{RISE}).” Any of the operating parameters, such as the peak-T_{LT} or peak-T_{HT}, are selectively modifiable by the adjustment module 32, as desired.

Using a fourth temperature difference between the peak-period temperature low tolerance peak-T_{LT} and the exterior temperature T_{OUT} at the beginning of the peak energy time period, the adjustment module 32 calculates a cooling rate with the cooling unit 14 turned-on and a time period TP_{REACH} for reaching the peak-period temperature set-point peak-T_{SP} at the beginning of the peak energy time period. The cooling operation starts at the time period T_{PREACH} before the beginning of the peak energy time period until the interior temperature T_{IN} reaches the peak-period temperature set-point peak-T_{SP} for the cooling operation.

The above detailed description and the examples described therein have been presented for the purposes of illustration and description only and not for limitation. For example, the operations described can be done in any suitable manner. The methods can be performed in any suitable order while still providing the described operation and results. It is therefore contemplated that the present embodiments cover any and all modifications, variations, or equivalents that fall within the scope of the basic underlying principles disclosed above and claimed herein. Furthermore, while the above description describes hardware in the form of a processor executing code, hardware in the form of a state machine, or dedicated logic capable of producing the same effect, other structures are also contemplated.

What is claimed is:

1. An environmental control system, comprising:
an interface module (42) configured to provide an interface associated with the environmental control system (10) for controlling operation of a network (22) connected to the environmental control system (10) and receiving operating data from at least one sensor associated with a target space;
a monitoring module (28) configured to receive the operating data via the interface module (42) and provide environmental condition information about the target space;
a detection module (30) configured to examine the operating data for controlling at least one environmental unit, to recognize an environmental condition change and identify a triggering event defined by a difference between at least two operating parameters of the environmental control system (10), and to determine a desired environmental operation based on the difference; and
an adjustment module (32) configured to adjust at least one operating parameter of the at least one environmental unit associated with the target space in response to the triggering event identified by the detection module (30).

2. The environmental control system of claim 1, wherein the interface module (42) includes a gateway unit (44) configured to provide a set of wireless routing rules supporting a communication technique via the network (22).

3. The environmental control system of claim 2, wherein the gateway unit (44) is an initial node in the network (22) configured for providing one or more connections between neighboring nodes (48a, 48b, 48c) in the network (22).

4. The environmental control system of claim 2, wherein the gateway unit (44) communicates with a routing unit (46) configured to be an interface computing device having an adaptive module configured for transferring messages between a server and a node in the network (22).

5. The environmental control system of claim 4, wherein the routing unit (46) is configured to send and receive the messages in at least one data packet in the network (22) between the environmental control system (10) and at least one neighboring node in the network (22).

6. The environmental control system of claim 1, wherein the monitoring module (28) is configured to provide the environmental condition information related to at least one of: interior and exterior environmental conditions of the target space.

7. The environmental control system of claim 1, wherein the at least one environmental unit includes at least one of: a cooling unit (14), a heating unit (16), a humidity unit (18), and a fan unit (24).

8. The environmental control system of claim 1, wherein the at least two operating parameters of the environmental control system (10) includes a first parameter associated with a temperature operation and a second parameter associated with a humidity operation.

9. The environmental control system of claim 1, further comprising an alert module (34) configured to inform a user of the triggering event and provide an option to change the triggering event by adjusting the at least one operating parameter related to the target space.

10. The environmental control system of claim 1, further comprising a display module (38) configured to interactively display an information message associated with the triggering event on a display device (26).

11. A method of operating an environmental control system, the method comprising:
providing an interface associated with the environmental control system (10) for controlling operation of a network (22) connected to the environmental control system (10);
receiving operating data from at least one sensor associated with a target space;
receiving the operating data via the interface module (42), and providing environmental condition information about the target space;
examining the operating data for controlling at least one environmental unit;
recognizing an environmental condition change and identifying a triggering event defined by a difference between at least two operating parameters of the environmental control system (10);
determining a desired environmental operation based on the difference; and
adjusting at least one operating parameter of the at least one environmental unit associated with the target space in response to the triggering event identified by the detection module (30).

12. The method of claim 11, further comprising providing a set of wireless routing rules supporting a communication technique via the network (22).

13. The method of claim 12, further comprising providing an initial node in the network (22) configured for providing one or more connections between neighboring nodes (48a, 48b, 48c) in the network (22).

14. The method of claim 12, further comprising communicating with a routing unit (46) configured to be an interface computing device having an adaptive module configured for transferring messages between a server and a node in the network (22).

15. The method of claim 14, further comprising sending and receiving the messages in at least one data packet in the network (22) between the environmental control system (10) and at least one neighboring node in the network (22).

16. The method of claim 11, further comprising providing the environmental condition information related to at least one of: interior and exterior environmental conditions of the target space.

17. The method of claim 11, further comprising including, as the at least one environmental unit, at least one of: a cooling unit (14), a heating unit (16), a humidity unit (18), and a fan unit (24).

18. The method of claim 11, further comprising including, as the at least two operating parameters of the environmental control system (10), a first parameter associated with a temperature operation and a second parameter associated with a humidity operation.

19. The method of claim 11, further comprising informing a user of the triggering event and providing an option to change the triggering event by adjusting the at least one operating parameter related to the target space.

20. The method of claim 11, further comprising interactively displaying an information message associated with the triggering event on a display device (26).
